(19) United States
(12) Patent Application Publication
(10) Pub. No.: US 2010/0177920 A1
(43) Pub. Date: Jul. 15, 2010

(54) A MICRO-SPEAKER

(75) Inventors: Xiao Xiang Shen, Shanghai (CN); Thean Kuie Christopher Chang, Singapore (SG)

Correspondence Address: CREATIVE LABS, INC.;LEGAL DEPARTMENT, 1901 MCCARTHY BLVD, MILPITAS, CA, 95035, US

(73) Assignee: Creative Technology Ltd., Singapore (SG)

(21) Appl. No.: 12/526,507

(22) PCT Filed: Feb. 7, 2007
(86) PCT No.: PCT/CN2007/000408

§ 371 Date: Mar. 8, 2010

(51) Int. Cl. H04R 1/02

(52) U.S. Cl. 381/338

(57) ABSTRACT

There is provided multiple embodiments of a micro-speaker that reproduces audio signals at a low resonant frequency, which correspondingly allows for low frequency reproduction of audio signals by the micro-speaker. The various embodiments of the micro-speaker may enable usage of spiders with larger areas such that mechanical compliance of the spider is increased.

### FIELD OF INVENTION

This invention relates to a micro-speaker that is able to reproduce audio signals at low frequencies using several different setups.

### BACKGROUND

Micro-speakers are commonly used in portable audio and multimedia systems for their small size, light weight and aesthetic appeal. However, the small size of such speakers is the primary reason why the acoustic performance of such speakers is not ideal. The small size of such speakers generally causes high resonant frequency fₛ, and low acoustic sensitivity.

Theile-Small theory states that the low frequency cutoff of loudspeakers is determined by its resonant frequency fₛ as per the following equation,

$${f}_{s} = \frac{1}{2 π} \frac{1}{\sqrt{{M}_{ms} {C}_{ms}}}$$

where Mₘₛ=total mass of vibration system (includes diaphragm, dustcap, voice coil, surround, spider, adhesive and additional radiation mass), and Cₘₛ=total mechanical compliance from surround and spider. Cₘₛ is determined as per the following equation,

$$\frac{1}{{C}_{ms}} = \frac{1}{{C}_{surr}} + \frac{1}{{C}_{spider}}$$

where Cₛᵤᵣᵣ=surround compliance, and C_{spider}=spider compliance.

Referring to the aforementioned equations, it can be seen that resonant frequency fₛ may be lowered if the total compliance Cₘₛ is larger.

### SUMMARY OF INVENTION

In a first embodiment of the present invention, there is provided a micro-speaker that includes a cylindrical diaphragm with a coil coupled to a first end of the diaphragm; and a horn coupled to a second end of the diaphragm, the horn mounted upon an upper part of a speaker frame. It is advantageous that induced vibration of the coil reproduces audio signals at a low resonant frequency, which correspondingly allows for low frequency reproduction of audio signals by the micro-speaker. A shape of the horn may affect either radiation area or radiation resistance.

The micro-speaker may further include a spider surrounding the cylindrical diaphragm, with the spider mounted in-between the upper part and a lower part of the speaker frame. The diaphragm may be made of either a metal or a metal alloy. A dustcap may be used to cover the second end of the diaphragm.

The reproduction of audio signals at low resonant frequency may be dependent upon a mechanical compliance of the spider, with the spider preferable being made of a material such as, for example, meta-aramid fibres, cotton or linen. The mechanical compliance of the spider may be dependent upon an area of the spider.

In a second embodiment of the present invention, there is provided a micro-speaker including: a cylindrical diaphragm with a coil coupled to a first end of the diaphragm; and a spider surrounding the diaphragm, the spider being mounted in-between an upper part and a lower part of a speaker frame. It is advantageous that induced vibration of the coil reproduces audio signals at a low resonant frequency, allowing for low frequency reproduction of audio signals by the micro-speaker. The reproduction of audio signals at low resonance frequency may be dependent upon a mechanical compliance of the spider. The mechanical compliance of the spider may be dependent upon an area of the spider.

The micro-speaker may further include a surround around a second end of the diaphragm with the diaphragm being made of either a metal or a metal alloy. A dustcap may cover the second end of the diaphragm. The surround may preferably be made of a material of high mechanical compliance such as, for example, rubber, cloth-immersed rubber, polymers, or foam cotton.

### DESCRIPTION OF DRAWINGS

In order that the present invention may be fully understood and readily put into practical effect, there shall now be described by way of non-limitative example only preferred embodiments of the present invention, the description being with reference to the accompanying illustrative drawings.

FIG. 1 shows a cross-sectional view of a first embodiment of the present invention.

FIG. 2 shows a perspective view of the first embodiment of the present invention.

FIG. 3 shows a cross-sectional view of a conventional micro-speaker.

FIG. 4 shows a resonance mode representation of a conventional micro-speaker using finite element analysis at low frequencies.

FIG. 5 shows a resonance mode representation of the first embodiment of the present invention using finite element analysis at low frequencies.

FIG. 6 shows a cross-sectional view of a second embodiment of the present invention.

FIG. 7 shows a perspective view of the second embodiment of the present invention.

FIG. 8 shows a resonance mode representation of the second embodiment of the present invention using finite element analysis at low frequencies.

### DESCRIPTION OF PREFERRED EMBODIMENTS

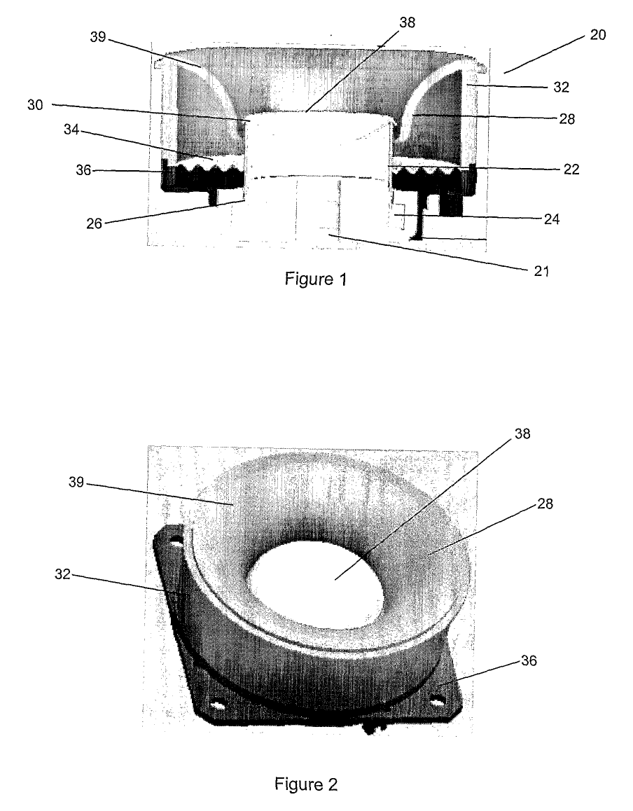

Referring to FIGS. 1 and 2, there is provided a cross-sectional and perspective view respectively of a first embodiment of the present invention in the form of a micro-speaker 20. The micro-speaker 20 includes a cylindrical diaphragm 22 with a coil 24 coupled to a first end 26 of the diaphragm 22. The diaphragm 22 may be made of either a metal or a metal alloy.

A horn 28 may be coupled to a second end 30 of the diaphragm 22. The coupling of the horn 28 to the second end 30 of the diaphragm 22 may be at or around an edge of the second end 30 of the diaphragm 22. The horn 28 may be securely mounted upon an upper part 32 of a speaker frame. There may be a dustcap 38 covering the second end 30 of the diaphragm 22. Radiation area and radiation resistance may be dependent upon a shape of the horn 28. The horn 28 may increase both radiation area and diaphragm radiation resistance, correspondingly enhancing sensitivity of the micro-speaker 20 in relation to sound reproduction.

The micro-speaker 20 may have a spider 34 surrounding the cylindrical diaphragm 22, with the spider 34 being mounted in-between the upper part of the speaker frame 32 and a lower part of the speaker frame 36. If the spider 34 has a larger outside diameter, the mechanical compliance of the spider 34 increases. The spider 34 may be made of materials such as, for example, meta-aramid fibres, cotton, linen and the like. The spider 34 may keep the coil 24 in a central position of the micro-speaker 20 by providing a restoring force if the coil 24 is displaced from the central position where the coil 24 surrounds a magnet 21.

When induced vibration of the coil 24 due to the magnet 21 in the micro-speaker 20 causes reproduction of audio signals, the micro-speaker 20 is able to reproduce audio signals at a low resonant frequency, allowing for low frequency reproduction of audio signals by the micro-speaker 20. The reproduction of audio signals at low resonant frequency is dependent upon the mechanical compliance of the spider 34, where the mechanical compliance of the spider 34 is dependent upon an area of the spider 34. The greater the area of the spider 34, the greater the mechanical compliance of the spider 34.

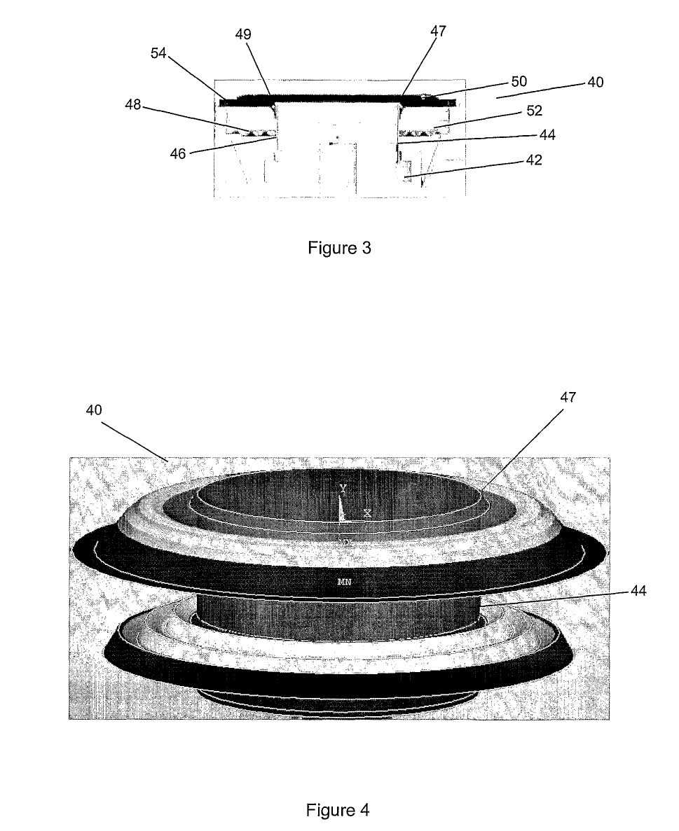

Referring to FIG. 3, there is shown a cross-sectional view of a conventional micro-speaker 40. It should be noted that a diameter of a coil 42 is nearly identical to a diameter of a diaphragm 44. An inner diameter 46 of a spider 48 is nearly identical to an inner diameter 49 of a surround 50, with the surround 50 being located at an exterior facing end 47 of the diaphragm 44. The surround 50 may be made of materials with high mechanical compliance, such as, for example, rubber, cloth-immersed rubber, polymers, foam cotton and the like. Due to considerations pertaining to assembly of the micro-speaker 40 during manufacture of the micro-speaker 40, an outside diameter 52 of the spider 48 is preferably less than an outside diameter 54 of the surround 50.

FIG. 4 shows a resonance mode representation of the conventional micro-speaker 40 using finite element analysis at low frequencies. Similarly, FIG. 5 shows a resonance mode representation of the first embodiment of the present invention using finite element analysis at low frequencies. It should be noted that the conventional micro-speaker 40 and the micro-speaker 20 of the first embodiment of the present invention may be dimensionally similar such that one may be used to replace the other if necessary. It should be observed that the micro-speaker 20 of the first embodiment of the present invention which includes the horn 28 rather than a surround does not significantly vibrate at a flared end 39 of the horn 28 compared to when the surround is used like in conventional micro-speakers. The micro-speaker 20 of the first embodiment of the present invention also includes the spider 34 that has a larger area than the spider 48 of the conventional micro-speaker 40. In this regard, the spider 34 has a higher mechanical compliance than the spider 48 leading to lower resonant frequency and correspondingly, extended low frequency reproduction. When comparing FIGS. 5 and 4, it should be noted that the flared end 39 of the horn 28 has less vibration compared to the second end 49 of the diaphragm 44. This results in less distortion of the reproduced audio signals.

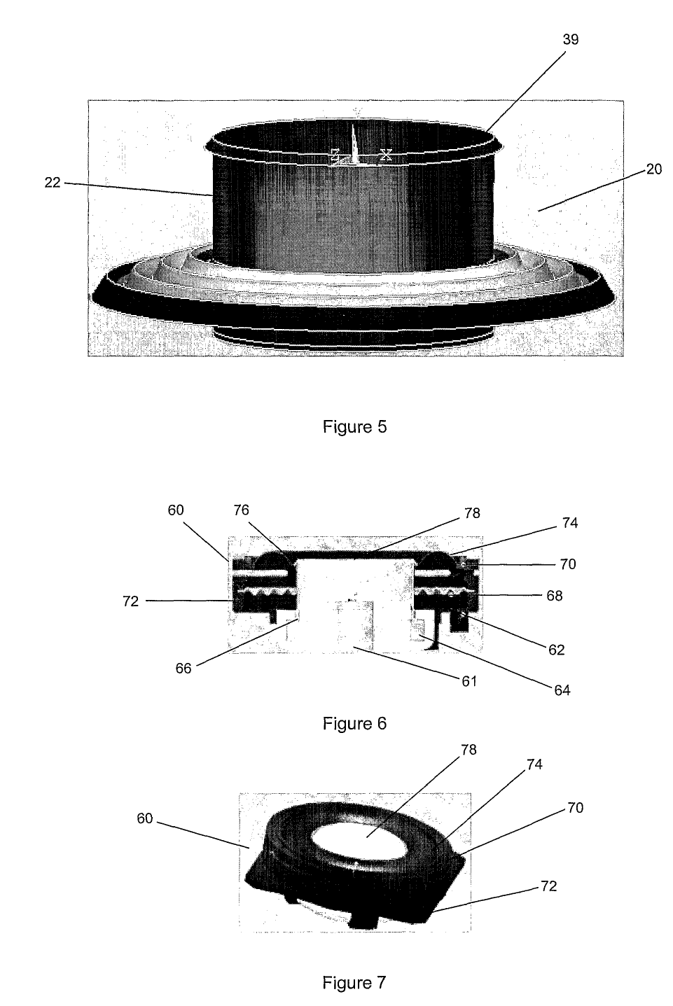

Referring to FIGS. 6 and 7, there is provided a cross-sectional and perspective view respectively of a second embodiment of the present invention in the form of a micro-speaker 60. The micro-speaker 60 includes a cylindrical diaphragm 62 with a coil 64 coupled to a first end 66 of the diaphragm 62. The diaphragm 62 may be made of either a metal or a metal alloy.

There may be a spider 68 surrounding the diaphragm 62. The spider 68 may be mounted between an upper part 70 of a speaker frame and a lower part 72 of the speaker frame. If the spider 68 has a larger outside diameter, the mechanical compliance of the spider 68 increases. The spider 68 may be made of materials such as, for example, meta-aramid fibres, cotton, linen and the like. The spider 68 may keep the coil 64 in a central position of the micro-speaker 60 by providing a restoring force if the coil 64 is displaced from the central position where the coil 64 surrounds a magnet 61.

The speaker 60 may include a surround 74 around a second end 76 of the diaphragm 62. The surround 74 may be located at or around an edge of the second end 76 of the diaphragm 62. The surround 50 may be made of materials with high mechanical compliance, such as, for example, rubber, cloth-immersed rubber, polymers, foam cotton and the like. There may be a dustcap 78 covering the second end 76 of the diaphragm 62. The micro-speaker 60 has an assembly rather similar to the conventional micro-speaker 40 as shown in FIG. 3, with the primary difference being the use of a multi-part speaker frame. The multi-part speaker frame facilitates a use of a bigger spider 68 with a larger outside diameter, resulting in a higher mechanical compliance of the spider 68.

When induced vibration of the coil 64 due to the magnet 61 in the micro-speaker 60 causes reproduction of audio signals, the micro-speaker 60 is able to reproduce audio signals at a low resonant frequency, allowing for low frequency reproduction of audio signals by the micro-speaker 60. The reproduction of audio signals at low resonant frequency is dependent upon the mechanical compliance of the spider 68 and the mechanical compliance of the spider 68 is dependent upon an area of the spider 68. The greater the area of the spider 68, the greater the mechanical compliance of the spider 68.

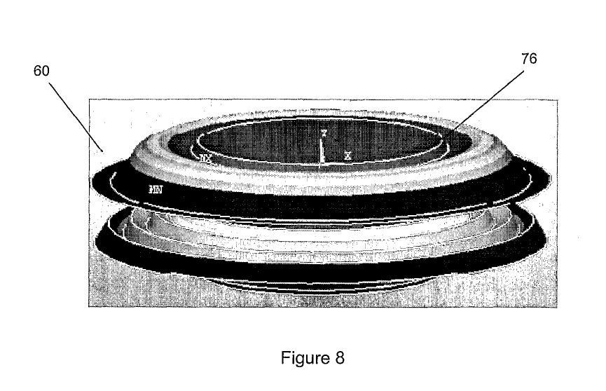

FIG. 8 shows a resonance mode representation of the second embodiment of the present invention using finite element analysis at low frequencies. It should be noted that the conventional micro-speaker 40 and the micro-speaker 60 of the second embodiment of the present invention may be dimensionally similar such that one may be used to replace the other if necessary. The micro-speaker 60 has an assembly rather similar to conventional micro-speaker 40 as shown in FIG. 3, with the primary difference being the use of a multi-part speaker frame. The micro-speaker 20 of the first embodiment of the present invention also includes the spider 34 that has a larger area than the spider 48 of the conventional micro-speaker 40. In this regard, the spider 68 has a higher mechanical compliance than the spider 48 leading to lower resonant frequency and correspondingly, extended low frequency reproduction. When comparing FIGS. 8 and 4, it should be noted that the second end 76 of the diaphragm 62 has less vibration compared to the second end 49 of the diaphragm 44. This results in less distortion of the reproduced audio signals.

Whilst there has been described in the foregoing description preferred embodiments of the present invention, it will be understood by those skilled in the technology concerned that many variations or modifications in details of design or construction may be made without departing from the present invention.

1-8. (canceled)

9. A micro-speaker including:
a cylindrical diaphragm with a coil coupled to a first end of the diaphragm;
a spider surrounding the diaphragm, the spider mounted in-between an upper part and a lower part of a speaker frame; and
a surround around a second end of the diaphragm;
wherein induced vibration of the coil reproduces audio signals at a low resonant frequency, allowing for low frequency reproduction of audio signals by the micro-speaker.

10. (canceled)

11. The micro-speaker of claim 9, wherein the diaphragm is made of either a metal or a metal alloy.

12. The micro-speaker of claim 9, wherein the low resonance frequency is dependent upon a mechanical compliance of the spider.

13. The micro-speaker of claim 9, wherein the spider is made of a material selected from the group consisting of: meta-aramid fibres, cotton and linen.

14. The micro-speaker of claim 9, further including a dustcap covering the second end of the diaphragm.

15. The micro-speaker of claim 12, wherein the mechanical compliance is dependant upon an area of the spider.

16. The micro-speaker of claim 9, wherein the surround is made of a material of high mechanical compliance selected from the group consisting of: rubber, cloth-immersed rubber, polymers, and foam cotton.
